(19) United States
(12) Patent Application Publication
(10) Pub. No.: US 2026/0127489 A1
(43) Pub. Date: May 7, 2026

(54) MONITORING DATA EVENTS FOR UPDATING MODEL

(71) Applicant: Nokia Technologies Oy, Espoo (FI)

(72) Inventors: Sivaramakrishnan SWAMINATHAN, Bangalore (IN); Stephen MWANJE, Munich (DE); Shuqiang SUN, Chengdu (CN)

(21) Appl. No.: 18/997,550

(22) PCT Filed: Aug. 5, 2022
(86) PCT No.: PCT/CN2022/110607

§ 371 Date: Jan. 22, 2025

(51) Int. Cl. G06N 20/00

(52) U.S. Cl. CPC G06N 20/00

(57) ABSTRACT

Example embodiments of the present disclosure relate to model updating. A device obtains a configuration indicating a data event for data associated with a model to be monitored. The data event indicates: a parameter to be monitored and a threshold associated with the parameter. The device triggers monitoring of the parameter and detects whether a value of the parameter fulfills a condition indicated in the configuration while monitoring the parameter. In this way, the training of the model is enhanced to handle data events.

### FIELD

Various example embodiments of the present disclosure generally relate to the field of telecommunications and in particular, to methods, devices, apparatuses and computer readable storage medium for updating models employed in a telecommunication system.

### BACKGROUND

In the telecommunication industry, technologies have been proposed to improve performance of telecommunication systems. For example, Artificial Intelligence/Machine Learning (AI/ML) models have been employed in telecommunication systems to improve the performance of telecommunications systems. Therefore, it is worthy studying on how to and when to update the AI/ML models employed in a telecommunication system.

### SUMMARY

In a first aspect of the present disclosure, there is provided a device. The device comprises at least one processor; and at least one memory storing instructions that, when executed by the at least one processor, cause the device at least to perform: obtaining a configuration indicating a data event for data associated with a model to be monitored, the data event indicating: a parameter to be monitored and a threshold associated with the parameter; triggering monitoring of the parameter based on the configuration indicating the data event; and detecting whether a value of the parameter fulfills a condition indicated in the configuration while monitoring the parameter.

In a second aspect of the present disclosure, there is provided a device. The device comprises at least one processor; and at least one memory storing instructions that, when executed by the at least one processor, cause the device at least to perform: transmitting, to another device, a configuration indicating a data event for data associated with a model to be monitored, the data event indicating: a parameter to be monitored and a threshold associated with the parameter.

In a third aspect of the present disclosure, there is provided a method. The method comprises: obtaining, at a device, a configuration indicating a data event for data associated with a model to be monitored, the data event indicating: a parameter to be monitored and a threshold associated with the parameter; triggering monitoring of the parameter based on the configuration indicating the data event; and detecting whether a value of the parameter fulfills a condition indicated in the configuration while monitoring the parameter.

In a fourth aspect of the present disclosure, there is provided a method. The method comprises: transmitting, at a device and to another device, a configuration indicating a data event for data associated with a model to be monitored, the data event indicating: a parameter to be monitored and a threshold associated with the parameter.

In a fifth aspect of the present disclosure, there is provided an apparatus. The apparatus comprises: means for obtaining a configuration indicating a data event for data associated with a model to be monitored, the data event indicating: a parameter to be monitored and a threshold associated with the parameter; means for triggering monitoring of the parameter based on the configuration indicating the data event; and means for detecting whether a value of the parameter fulfills a condition indicated in the configuration while monitoring the parameter.

In a sixth aspect of the present disclosure, there is provided an apparatus. The apparatus comprises means for transmitting, to another apparatus, a configuration indicating a data event for data associated with a model to be monitored, the data event indicating: a parameter to be monitored and a threshold associated with the parameter.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A and FIG. 1B illustrate example communication environments in which example embodiments of the present disclosure can be implemented;

FIG. 2A and FIG. 2B illustrate signaling diagrams for communication according to some example embodiments of the present disclosure;

FIG. 3 illustrates a signaling diagram for communication according to some example embodiments of the present disclosure;

FIG. 4 illustrates a signaling diagram for communication according to some example embodiments of the present disclosure;

FIG. 5 illustrates a signaling diagram for communication according to some example embodiments of the present disclosure;

FIG. 6A to FIG. 6D illustrate schematic diagrams of modelling according to some example embodiments of the present disclosure;

FIG. 7 illustrates a flowchart of a method according to some example embodiments of the present disclosure;

FIG. 8 illustrates a flowchart of a method according to some example embodiments of the present disclosure;

FIG. 9 illustrates a flowchart of a method according to some example embodiments of the present disclosure;

FIG. 10 illustrates a simplified block diagram of a device that is suitable for implementing example embodiments of the present disclosure; and

FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As mentioned above, it is worthy studying on how to and when to update an AI/ML model of a network function of a wireless communication system, such as a 5G wireless communication system (5GS). In some solutions, the AI/ML management capabilities and services for 5GS where an AI/ML model is used are specified. An AI/ML entity is either an AI/ML model or contains an AI/ML model and that can be managed as a single composite entity. The AI/ML training related capabilities and the services are specified as part of the current scope. An AI/ML training function playing the role of AI/ML training MnS producer, may consume various data for AI/ML model training purposes to train or retrain an AI/ML model.

AI/ML Training (AIMLT) MnS producer triggers the job of AI/ML training. According to some solutions, the job of AI/ML training may be triggered based on request from AIMLT MnS Consumer. However, it is benefit that the job of AI/ML training may be triggered by AIMLT MnS Producer itself without an explicit request for the AIMLT MnS consumer. In particular, given changes in the network, the AIMLT MnS producer may trigger AI/ML training based on new network events. To trigger the AI/ML training on its own for a given use case, the AIMLT MnS producer needs to monitor applicable network events and their changes. The AI/ML training can then be triggered based on some specified characteristics or on the conditions related to the observed network events. However, there is no means for enabling the AIMLT MnS producer to know the type of network events or monitoring the required data. Also, there is no method for AIMLT MnS provider to perform and determine the need to trigger new training or retraining of an AI/ML model.

### Example Environment

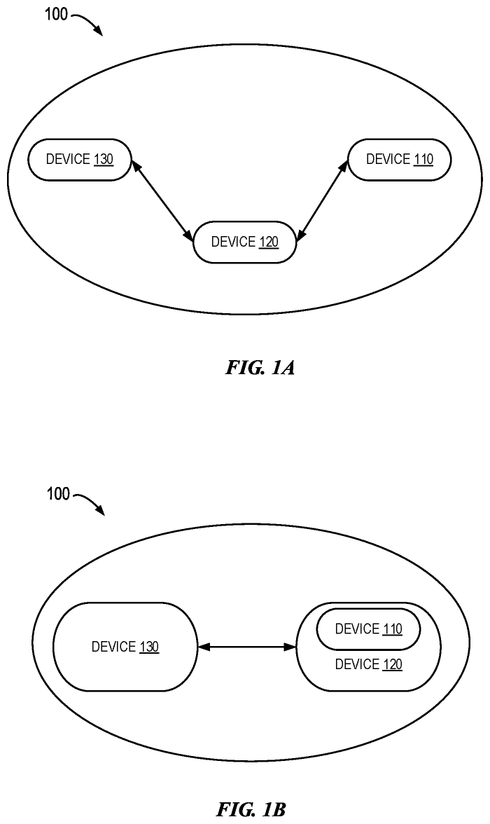

FIG. 1A and FIG. 1B illustrate examples of devices of a wireless communication system 100, for example a 5G wireless communication system (5GS), in which example embodiments of the present disclosure can be implemented. The devices include a device 110, a device 120 and a device 130 which can communicate with each other via either a wired and/or wireless connection. In some example embodiments, the device 110 may include an AIML data monitoring module or entity. The AIML data monitoring module or entity described herein may be an independent information object class (IOC) performing an intended function. In some example embodiments, the device 120 may include a producer, for example, an AIML management service (MnS) producer. For example, the device 120 may be a network management node of the wireless communication system, a base station of a radio access network of the wireless communication system 100, or a core network device (e.g., a network device of a core network) of the wireless communication system 100). In some example embodiments, the device 120 may include other producers. In some example embodiments, the device 130 may include a consumer, for example, an AIML MnS consumer. For example, the AIML MnS consumer may be an analytics consumer or an operator. In some examples, the device 120 and the device 130 may include one or more network functions. Alternatively, the device 120 and device 130 may include management functions or operation, administration and maintenance (OAM) functions. The term “function” used herein can refer to a physical module or a virtual module.

In some example embodiments, the device 110, the device 120 and the device 130 may be implemented on one device. Alternatively, the device 110, the device 120 and the device 130 may be implemented on difference devices. For example, as shown in FIG. 1A, the device 110, the device 120 and the device 130 may be implemented on three difference devices. In some example embodiments, the device 120 and the device 130 may be implemented on one device while the device 110 may be implemented on another device. Alternatively, the device 110 and the device 120 may be implemented on one device while the device 130 may be implemented on another device. For example, as shown in FIG. 1B, the device 110 may be a part of the device 120. In some example embodiment, the device 110 and the device 130 may be implemented on one device while the device 120 may be implemented on another device.

It is to be understood that the number of devices and their connections shown in FIG. 1 are only for the purpose of illustration without suggesting any limitation. The wireless communication system 100 may include any suitable number of devices configured to implementing example embodiments of the present disclosure.

In some example embodiments, a link from a network device (e.g., a base station or a core network device) to a terminal device is referred to as a downlink (DL), while a link from the terminal device to the network device (e.g., a base station or a core network device) is referred to as an uplink (UL). In DL, the network device is a transmitting (TX) device (or a transmitter) and the terminal device is a receiving (RX) device (or a receiver). In UL, the terminal device is a TX device (or a transmitter) and the network device is a RX device (or a receiver).

Communications in the wireless communication system 100 may be in accordance with implemented according to any communication protocol(s), comprising, but not limited to, cellular communication protocols of the first generation (1G), the second generation (2G), the third generation (3G), the fourth generation (4G), the fifth generation (5G), the sixth generation (6G) radio access technologies, and/or any other protocols currently known or to be developed in the future. Moreover, the communication between a base station and a terminal may utilize any suitable technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Work Principle and Example Signaling for Communication

According to some example embodiments of the present disclosure, there is provided a solution for updating an AI/ML model. In this solution, a producer of a device obtains a configuration from a consumer where the configuration indicates a data event for data associated with a AI/ML model to be monitored. The data event indicates: a parameter to be monitored and a threshold associated with the parameter. The device includes a producer which triggers am AI/ML data monitoring module or entity to perform monitoring of the parameter and detect whether a value of the parameter fulfills a condition indicated in the configuration while monitoring the parameter. In this way, the updating of the model is enhanced to handle data events.

Example embodiments of the present disclosure will be described in detail below with reference to the accompanying drawings.

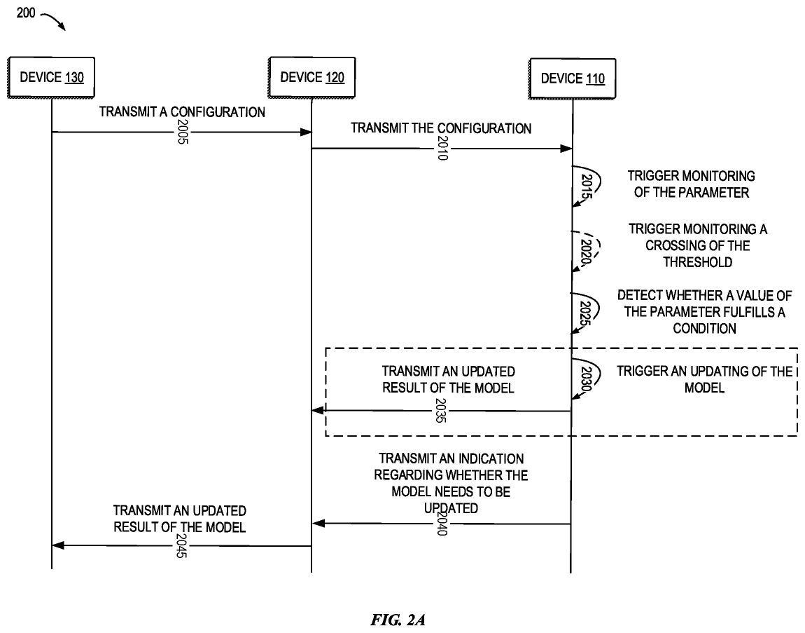

Reference is now made to FIG. 2A, which shows a signaling diagram 200 for communications according to some example embodiments of the present disclosure. As shown in FIG. 2A, the signaling diagram 200 shows signaling between a device 110, a device 120, and a device 130. For the purpose of discussion, reference is made to FIG. 1A to describe the signaling diagram 200 where the device 110 is separated from or outside of the device 120. Although one device 110 and one device 130 are illustrated in FIG. 2A, it would be appreciated that there may be a plurality of devices performing similar operations as described with respect to the device 110 below and a plurality of third device performing similar operations as described with respect to the device 130 below.

The device 130 transmits 2005 a configuration indicating a data event for data associated with an AI/ML model (“model”) to the device 120. In some example embodiments, the model may be referred to as an AIML entity. The AIML entity may have a list of data events to be monitored for (re) training. The data event is to be monitored. The data event indicates one or more parameters to be monitored. For example, the one or more parameters may comprise a performance measurement (PM) to be monitored. Alternatively, or in addition, the one or more parameters may comprise a key performance indicator (KPI) to be monitored. In some example embodiments, the one or more parameters may comprise a network control parameter. Alternatively, the one or more parameters may comprise a network performance metric. In some other example embodiments, the one or more parameters may comprise a communication environmental parameter. The data event also indicates a threshold associated with the parameter. For example, the data event may indicate a threshold value. In some example embodiments, the data event may indicate a threshold direction. For example, the threshold direction may indicate above the threshold or below the threshold. Alternatively, or in addition, the data event may comprise a hysteresis value. In this way, the updating of the model is enhanced to handle data events.

In some example embodiments, the data event may comprise a threshold periodicity of a notification associated with fulfilling the condition indicated in the configuration. For example, the data event may comprise the periodicity of (re) training based on the notifications of crossing of the threshold. The periodicity may imply the number of the threshold notifications to be received for considering retraining. For example, a particular PM may be configured to be monitored for a value of above 100 and a notification would be transmitted every time the values are above 100. The data event may be enabled to configure the number of such notifications that may be received before triggering the decision for training or retraining. Only as an example, the parameter indicated in the data event may be the number of terminal devices connected to a network. The threshold indicated in the data event may be 95% of the maximum number of terminal devices. The threshold direction may be above the threshold.

In some example embodiments, the configuration may be transmitted in a request for AIML training. In some example embodiments, AIMLTrainingRequest IOC may be extended to have a new information element (IE) to accommodate the data event to be monitored. For example, Table 1 below shows an example of the request for AIML training. It should be notated that Table 1 is only an example not limitation.

TABLE 1

| | Support | | | | |
|---|---|---|---|---|---|
| Attribute name | Qualifier | isReadable | isWritable | isInvariant | isNotifyable |
| aIMLEntityId | M | T | T | F | T |
| candidateTraingDataSource | O | T | T | F | T |
| traingDataQualityScore | O | T | T | F | T |
| trainingRequestSource | M | T | T | F | T |
| requestStatus | M | T | T | F | T |
| expectedRuntimeContext | O | T | T | F | T |
| performanceRequirements | M | T | T | F | T |
| cancelRequest | O | T | T | F | T |
| suspendRequest | O | T | T | F | T |
| monitoredDataEvents | O | T | T | F | T |

The attribute “MonitoredDataEvents «dataType»” may represent the data events that need be monitored to decide on the need for the retraining by the AIMLT MnS producer. This includes the PM(s) and the KPI(s) to be monitored, their granularity period, and the scope for producing the PM(s) and the KPI(s). This also includes the threshold related configurations direction, value, and the hysteresis value. The notifications specified for the IOC using this «dataType» for its attribute(s), may be applicable. Table 2 below shows an example of the MonitoredDataEvents. It should be notated that Table 2 is only an example not limitation.

TABLE 2

| | Support | | | | |
|---|---|---|---|---|---|
| Attribute name | Qualifier | isReadable | isWritable | isInvariant | isNotifyable |
| thresholdInfoList | M | T | T | F | T |
| kpi | O | T | T | F | T |
| granularityPeriod | M | T | T | F | T |
| notificationThreshold | M | T | T | F | T |
| objectInstances | M | T | T | F | T |
| rootObjectInstances | O | T | T | F | T |

As mentioned above, the model may be referred to as an AIML entity. In some example embodiments, the AIML entity may be modeled as an IOC and the following new IEs (such as data event and its details) may be stored in the AIML entity. This IOC “AIMLEntity” may represent an AI/ML entity which could be either an AI/ML model or AI/ML-enabled function containing the AI/ML model. AIML training may be requested for either an AI/ML model or AI/ML-enabled function. The algorithm of AI/ML model or AI/ML-enabled function is not to be standardized. For each AIMLEntity under training, one or more AIMLTrainingProcess may be instantiated. The AIMLEntity may contain 3 types of contexts-TrainingContext which is the context under which the AIMLEntity has been trained, the ExpectedRunTimeContext which is the context where an AIMLEntity is expected to be applied or/and the RunTimeContext which is the context where the model is being applied. The AIML entity may also contain the data events that are monitored to update the respective AIML entity. The IOC “AIMLEntity” may include attributes inherited from Top IOC and the following attributes (shown in Table 3). The common notifications may be valid for this IOC, without exceptions or additions. Table 4 shows an example of attribute constraints. It should be notated that Tables 3 and 4 are only examples not limitations.

TABLE 3

| | Support | | | | |
|---|---|---|---|---|---|
| | Qualifier | isReadable | isWritable | isInvariant | isNotifyable |
| Attribute name | | | | | |
| inferenceType | M | T | F | F | T |
| aIMLEntityVersion | M | T | F | F | T |
| expectedRunTimeContext | O | T | T | F | T |
| trainingContext | CM | T | F | F | T |
| runTimeContext | O | T | F | F | T |
| monitoredDataevents | O | T | F | F | T |
| Attribute related to role | | | | | |
| trainingProcessRef | M | T | F | F | T |
| trainingRequestRef | CM | T | F | F | T |
| trainingReportRef | M | T | F | F | T |

TABLE 4

| Name | Definition |
|---|---|
| trainingContext | Condition: The trainingContext represents the status |
| Support Qualifier | and conditions related to training and should be added |
| | when training is completed |

The device 120 transmits 2010 the configuration indicating the data event to the device 110. As mentioned above, the data event indicates a parameter to be monitored. For example, the parameter may comprise a PM to be monitored. Alternatively, or in addition, the parameter may comprise a KPI to be monitored. The data event also indicates a threshold associated with the parameter. For example, the data event may indicate a threshold value. In some example embodiments, the data event may indicate a threshold direction. For example, the threshold direction may indicate above the threshold or below the threshold. Alternatively, or in addition, the data event may comprise a hysteresis value. In this way, the training of the model is enhanced to handle data events.

In some example embodiments, the device 110 may refer to an AIML data monitoring. For example, the AIML data monitoring may be an independent function. Alternatively, the AILML data monitoring may be a sub routine inside a function. In case of an independent function, following information may detail the definition of the AIML data monitoring IOC. The IOC “AIMLDataMonitoring” may represent the data events those are to be monitored for an AIML entity. The “AIMLDataMonitoring” Managed Object Instance (MOI) may be contained under one AIMLTrainingFunction MOI. The common notifications may be valid for this IOC, without exceptions or additions. Table 5 shows an example of attributes.

TABLE 5

| | Support | | | | |
|---|---|---|---|---|---|
| Attribute name | Qualifier | isReadable | isWritable | isInvariant | isNotifyable |
| aIMLEntityId | M | T | F | F | T |
| monitoredDataevents | M | T | F | F | T |

The device 110 triggers 2015 monitoring of the parameter. In some example embodiments, based on the parameter to be monitored, the device 110 may trigger a fifth device for monitoring the parameter. For example, the device 110 may instantiate a “PerMetricJob” (performance metric job) for monitoring the parameter. In some example embodiments, if the data event includes the KPI to be monitored, the device 110 may determine one or more PMs associated for the KPI. In this case, the device 110 may be triggered for monitoring the determined one or more PMs.

The device 110 may trigger 2020 to monitoring of fulfilling a condition indicated in the configuration. In some example embodiments, the device 110 may trigger a sixth device for monitoring the crossing of the threshold. For example, the device 110 may instantiate or trigger a “ThresholdMonitor” job for monitoring the crossing of the threshold. The term “the crossing of the threshold” may refer to reaching the threshold. The sixth device may monitor one or more of: the threshold, the threshold direction and the hysteresis value for the data event. In this case, the sixth device may transmit a notification of the crossing of the threshold, if the threshold is crossed in the configured direction considering the hysteresis value (if configured).

The device 110 detects 2025 whether a value of the parameter fulfills a condition indicated in the configuration while monitoring the parameter. For example, in some example embodiments, the condition may be a value of particular PM above 100. In this case, the device 110 may detect whether the value of the PM is above 100. If the value of PM is above 100, the device 110 may detect that the condition fulfilled. Alternatively, if the value of PM is not above 100, the device 110 may detect that the condition is not fulfilled.

In some example embodiments, the device 110 may determine a periodicity of a notification associated with the crossing of the threshold. Alternatively, or in addition, the device 110 may determine a threshold direction of the crossing of the threshold. In this case, the device 110 may determine whether the value of the parameter fulfills the condition based on the periodicity of notification and the threshold direction. For example, the device 110 may determine whether the periodicity reaches the threshold periodicity. The device 110 may determine whether the threshold direction satisfied a configured direction. In this case, if the periodicity of notifications reaches the threshold periodicity and the threshold direction satisfies the configured direction, the device may determine that value of the parameter fulfills the condition. In some example embodiments, if the periodicity of notifications does not reach the threshold periodicity, the device 110 may determine that the model does not need to be updated. Alternatively, or in addition, if the threshold direction does not satisfy the configured direction, the device 110 may determine that the model does not need to be updated. In some example embodiments, the monitoring information may comprise a monitored PM. In this case, the device 110 may determine a KPI based on the monitored PM.

Only as an example, the device 110 may consume the notifications transmitted from the “ThresholdMonitor” job. In this case, these notifications may be compared against the acceptable periodicity configured in the device 110 for a given data event. Based on that, the device 110 may determine whether to initiate (re) training or not. For example, the device 110 may receive a plurality of notifications of the crossing of the threshold. In this case, if the number of the notifications reaches a threshold number indicated in the data event, the device 110 may determine that the model needs to be updated.

In some example embodiments, the device 110 may trigger 2030 an updating of the model. For example, the device 110 may directly instantiate the AIML training process corresponding to the model that needs to be trained or retrained. In this case, the device 110 may receive an updated result of the model. The device 110 may transmit 2035 an updated result of the model to the device 120. In some example embodiments, the updating of the model may comprise one or more of: training the model, retraining the model, updating a hyper parameter of the model, updating the configuration indicating the data event associated with the model, or updating a running context of the model. The term “hyper parameter” used herein can refer to a tunning parameter in a machine learning algorithm which is set by a user.

Alternatively, the device 110 may transmit 2040 an indication regarding whether the model needs to be updated to the device 120. In this case, in some example embodiments, the device 120 may evaluate the notifications and the events and decide the need for (re) training. In this case, the device 120 may perform the retraining if required. For example, the device 120 may trigger the update of the model. For example, if the retraining or training of the model is needed, the device 120 may instantiate the AIML training process for the model and the updated result of the updated training may be provided to the device 130 by the device 120. In some example embodiments, the device 120 may transmit 2045 the updated result of the model to the device 130. In this case, in some example embodiments, the updated result of the model may comprise one or more of: the newly training model, the retraining model, the updated hyper parameter of the model, the updated configuration indicating the data event associated with the model, or an updated running context of the model.

In some example embodiments, the device 130 may reconfigure the data event to be monitored for the model. In this case, the device 130 may update the model with the reconfigured values for the data events. The reconfigured values may then be indicated to the device 110 to start monitoring the updated events.

Reference is now made to FIG. 2B, which shows a signaling diagram 201 for communication according to some example embodiments of the present disclosure. As shown in FIG. 2B, the signaling diagram 201 involves a device 110, a device 120, and a device 130. For the purpose of discussion, reference is made to FIG. 1B to describe the signaling diagram 200 where the device 110 is a part of the device 120.

The device 130 transmits 2105 a configuration indicating a data event for data associated with a model to the device 120. In some example embodiments, the model may refer to an AIML entity. The AIML entity may have a list of data events to be monitored for (re) training. The data event is to be monitored. The data event indicates one or more parameters to be monitored. For example, the one or more parameters may comprise a performance measurement (PM) to be monitored. Alternatively, or in addition, the one or more parameters may comprise a key performance indicator (KPI) to be monitored. In some example embodiments, the one or more parameters may comprise a network control parameter. Alternatively, the one or more parameters may comprise a network performance metric. In some other example embodiments, the one or more parameters may comprise a communication environmental parameter. The data event also indicates a threshold associated with the parameter. For example, the data event may indicate a threshold value. In some example embodiments, the data event may indicate a threshold direction. For example, the threshold direction may indicate above the threshold or below the threshold. Alternatively, or in addition, the data event may comprise a hysteresis value. In this way, the training of the model is enhanced to handle data events.

In some example embodiments, the data event may comprise a threshold periodicity of a notification associated with fulfilling the condition indicated in the configuration. For example, the data event may comprise the periodicity of (re) training based on the notifications of crossing of the threshold. The periodicity may imply the number of the threshold notifications to be received for considering retraining. For example, a particular PM may be configured to be monitored for a value of above 100 and a notification would be transmitted every time the values goes above 100. The data event may be enabled to configure the number of such notifications that may be received before triggering the decision for (re) training. Only as an example, the parameter indicated in the data event may be the number of terminal devices connected to a network. The threshold indicated in the data event may be 95% of the maximum number of terminal devices. The threshold direction may be above the threshold.

In some example embodiments, the configuration may be transmitted in a request for AIML training. In some example embodiments, AIMLTrainingRequest IOC may be extended to have a new information element (IE) to accommodate the data event to be monitored. For example. Table 1 below shows an example of the request for AIML training.

The device 120 (for example, the device 110 inside the device 120) triggers 2110 monitoring of the parameter. In some example embodiments, based on the parameter to be monitored, the device 120 may trigger a fifth device for monitoring the parameter. For example, the device 120 may instantiate a “PerMetricJob” (performance metric job) for monitoring the parameter. In some example embodiments, if the data event includes the KPI to be monitored, the device 120 may determine one or more PMs associated for the KPI. In this case, the device 120 may be triggered for monitoring the determined one or more PMs.

The device 120 (for example, the device 110 inside the device 120) may trigger monitoring of fulfilling a condition indicated in the configuration. In some example embodiments, the device 120 may trigger a sixth device for monitoring the crossing of the threshold. For example, the device 120 may instantiate or trigger a “ThresholdMonitor” job for monitoring the crossing of the threshold. The term “the crossing of the threshold” may refer to reaching the threshold. The sixth device may monitor one or more of: the threshold, the threshold direction and the hysteresis value for the data event. In this case, the sixth device may transmit a notification of the crossing of the threshold, if the threshold is crossed in the configured direction considering the hysteresis value (if configured).

The device 120 (for example, the device 110 inside the device 120) detects 2115 whether a value of the parameter fulfills a condition indicated in the configuration while monitoring the parameter. For example, in some example embodiments, the condition may be a value of particular PM above 100. In this case, the device 120 may detect whether the value of the PM is above 100. If the value of PM is above 100, the device 120 may detect that the condition fulfilled. Alternatively, if the value of PM is not above 100, the device 120 may detect that the condition is not fulfilled.

In some example embodiments, the device 120 may determine a periodicity of a notification associated with the crossing of the threshold. Alternatively, or in addition, the device 120 may determine a threshold direction of the crossing of the threshold. In this case, the device 120 may determine whether the value of the parameter fulfills the condition based on the periodicity of notification and the threshold direction. For example, the device 120 may determine whether the periodicity reaches the threshold periodicity. The device 120 may determine whether the threshold direction satisfied a configured direction. In this case, if the periodicity of notifications reaches the threshold periodicity and the threshold direction satisfies the configured direction, the device may determine that value of the parameter fulfills the condition. In some example embodiments, if the periodicity of notifications does not reach the threshold periodicity, the device 120 may determine that the model does not need to be updated. Alternatively, or in addition, if the threshold direction does not satisfy the configured direction, the device 120 may determine that the model does not need to be updated. In some example embodiments, the monitoring information may comprise a monitored PM. In this case, the device 120 may determine a KPI based on the monitored PM.

Only as an example, the device 120 may consume the notifications transmitted from the “ThresholdMonitor” job. In this case, these notifications may be compared against the acceptable periodicity configured in the device 110 for a given data event. Based on that, the device 110 may determine whether to initiate (re) training or not. For example, the device 110 may receive a plurality of notifications of the crossing of the threshold. In this case, if the number of the notifications reaches a threshold number indicated in the data event, the device 110 may determine that the model needs to be updated.

The device 120 may update 2120 the model. For example, if the retraining or training of the model is needed, the device 120 may instantiate the AIML training process for the model and the updated result of the updated training may be provided to the device 130 by the device 120. In some example embodiments, the device 120 may transmit 2125 the updated result of the model to the device 130. In this case, in some example embodiments, the updated result of the model may comprise one or more of: the newly trained model, the re-trained model, the updated hyper parameter of the model, the updated configuration indicating the data event associated with the model, or an updated running context of the model.

According to example embodiments of the present disclosure, it proposes means for a 3GPP management system to enable an authorized consumer to configure the AIMLT MnS producer to trigger training for a given AI/ML entity as well as means to enable the AIMLT MnS producer to independently trigger training based on network events or the changes thereof and as configured by the AIMLT MnS consumer. Specifically, it proposes: capabilities and meta data for an AI/ML entity that enables AIMLT MnS producer to initiate training for that specific AI/ML entity. The following features are proposed in AI/ML entity: AI/ML entity is enabled with a list of events to be monitored for (re) training; the data event represents the information to be monitored. e.g., a PM or a KPI; each data event may be associated with a threshold monitor; and each data event also defines the need for retraining upon indication from threshold monitor.

In addition, according to example embodiments of the present disclosure, it proposes capabilities and features of the AIMLT MnS consumer that enables a consumer to configure the AIMLT MnS producer to trigger training for a given AI/ML Entity. The Following features are proposed in AIMLT MnS producer and consumer: AIMLT consumer can configure/request the AIML training to the producer based on certain data events; this configuration shall contain data events which may be a PM or a KPI to be monitored by the producer; these data events are monitored for a configured threshold; and the producer decides on (re) training based on the breaching of the configured thresholds.

Moreover, according to example embodiments of the present disclosure, it proposes capabilities and features of the AIMLT MnS producer that enables a consumer to configure the AIMLT MnS producer and that enables the AIMLT MnS producer to trigger (re) training for a given AI/ML Entity. The Following features are proposed in AIMLT MnS producer and consumer: producer or the ML App thereof is configured; then producer monitors the configured events and conditions; the producer triggers training as needed; and then producer may report on the training instance.

According to example embodiments of the present disclosure, it enables the AIML producer to receive information regarding the data sources that need to be monitored. Further it also proposes a possible solution to perform the analysis of the data and decide whether a new training or retraining to be performed.

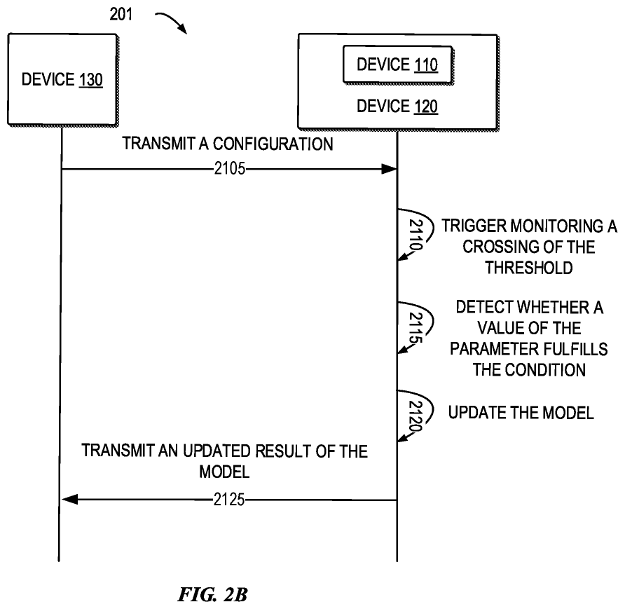

FIG. 3 illustrates a signaling diagram for interaction 300 between an AIMLT MnS consumer 310 and an AIMLT MnS producer 320. For example, the AIMLT MnS consumer 310 may be implemented on the device 130 and the AIMLT MnS producer 320 may be implemented at the device 120.

The AIMLT MnS consumer 310 may transmit 3010 an AIML training request with a configuration of data event to be monitored. The data event may comprise one or more of: information to be monitored (PM(s) and/or KPI(s)), a threshold value, a threshold direction, a hysteresis value, or an acceptable periodicity of the threshold notification which implies the number of the threshold notifications to be received for considering retraining.

The AIMLT MnS producer 320 may instantiate 3020 the data monitoring. Data monitoring may subsequently instantiate other jobs on PM(s) and/or KPI(s) depending on the configured data events.

The AIMLT MnS producer 320 may receive 3030 the notification on the monitored data event from the data monitoring or from the instantiated jobs by the data monitoring. This notification may indicate the need for (re) training.

The AIMLT MnS producer 320 may evaluate 3040 the notifications and/or the events. The AIMLT MnS producer 320 may decide the need for (re) training. The AIMLT MnS producer 320 may perform 3050 the retraining if required. The AIMLT MnS producer 320 may provide the results of the updated training to the AIMLT MnS consumer 310.

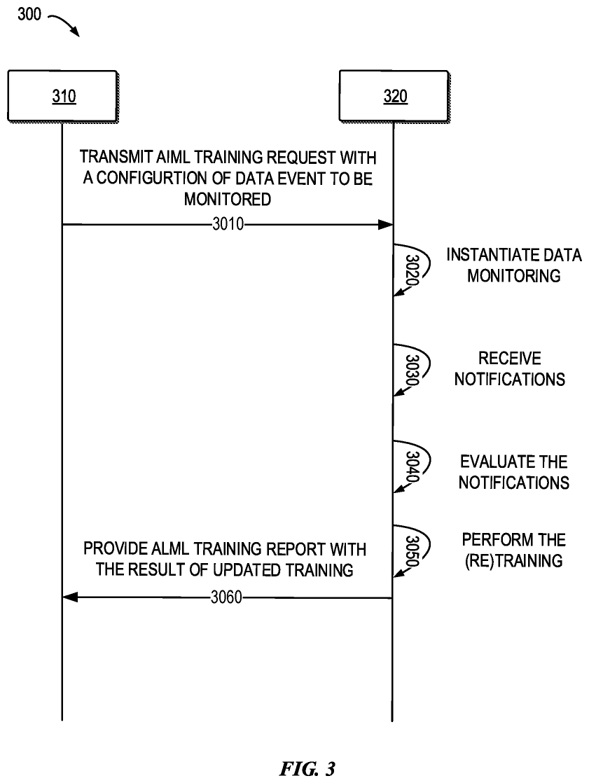

FIG. 4 illustrates a signaling diagram for interaction 400 between an AIMLT MnS consumer and an AIMLT entity. As shown in FIG. 4, the interactions 400 may involve an AIMLT MnS consumer 410, an AIMLT MnS producer 420, and an ALML data monitoring function 430. For example, the AIMLT MnS consumer 410 may be implemented on the device 130 and the ALML data monitoring function 430 may be implemented at the device 110. Alternatively, the ALML data monitoring function 430 may be implemented at the device 120.

In some example embodiments, post performing the initial training based on the training request, the AIMLT MnS producer may produce a new object of the AIML entity (for example, a newly trained AIML model, or a new version of AIML application with a newly trained model). This AIML entity instance may contain information defined in the AIML Entity IOC. This information may also contain the data events those are monitored for the specific AIML entity 420.

The AIMLT MnS consumer 410 may change or reconfigure 4010 the data event including the data events themselves (PM(s)/KPI(s)) or the granularity period or the object instances that need be scoped for the data event generation. The AIMLT MnS consumer 410 may then directly update the AIML entity 420 for the required changes and reconfigure the data events. The AIML entity 420 may reconfigure 4020 the data event to the AIML data monitoring function 430. The AIML data monitoring function 430 may perform 4030 the required action on the perfmetric and threshold monitor jobs. For example, the perfmetric jobs and the threshold metric jobs may be updated appropriately. The AIML data monitoring function 430 may respond 4040 to the AIML entity 420 with a success or a failure of the reconfiguration of the data event. The AIML entity 420 may response 4050 to the AIMLT MnS consumer 410 with a success or a failure of the reconfiguration of the data event.

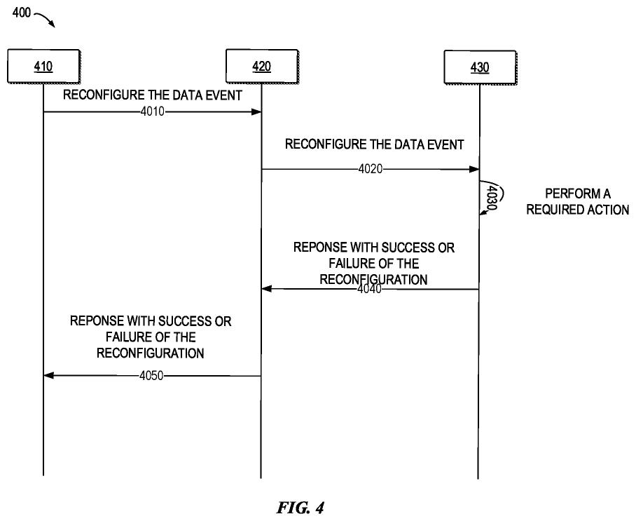

FIG. 5 illustrates a signaling diagram for interaction 500 among devices. As shown in FIG. 5, the interactions 500 may involve an AIMLT MnS consumer 510, an AIMLT MnS producer 520, an ALML data monitoring function 530, a MnS producer PerMetric job 540, a MnS producer ThresholdMonitor job 550, an AIML training entity 560, an AIML training entity 570. For example, the AIMLT MnS consumer 510 may be implemented on the device 130, the ALML data monitoring function 530 may be implemented at the device 110, and the AIMLT MnS producer 520 may be implemented at the device 120.

The AIMLT MnS consumer 510 may transmit 5001 a training request to the AIMLT MnS producer 520. This training request may contain the configuration of the data events to be monitored by the producer. The data event may include one or more of the following information: information to be monitored (PM(s) and/or KPI(s)), a threshold value, a threshold direction, a hysteresis value, or an acceptable periodicity of the threshold notification.

The AIMLT MnS producer 520 may instantiate 5002 the data monitoring based on the configured data events to be monitored. If the configured data events contains KPIs, the ALML data monitoring function 530 may deduce 5003 the appropriate PMs for those KPIs.

The ALML data monitoring function 530 may instantiate 5004 the MnS producer PerMetric job 540 for the configured/deduced PMs. The ALML data monitoring function 530 may instantiate 5005 the MnS producer ThresholdMonitor job 550 for the configured and deduced PMs. The MnS producer ThresholdMonitor job 550 may monitor 5006 the configured/deduced PMs for the threshold crossings. The MnS producer ThresholdMonitor job 550 may transmit 5007 a notification in the event of threshold crossing of the configured/deduced PMs.

The ALML data monitoring function 530 may check 5008 if the acceptable periodicity has reached for a given data event. For example, notifications received at AIML data monitoring may be checked against the acceptable number of occasions as per the data event configuration.

The ALML data monitoring function 530 may deduce 5009 KPIs from the appropriate PMs. The ALML data monitoring function 530 may determine 5010 the need for (re) training.

AIML (re) training may be initiated by the ALML data monitoring function 530 itself. Alternatively, the ALML data monitoring function 530 may indicate to the AIMLT MnS producer 520 and the AIMLT MnS producer 520 may then trigger the (re) training.

In case of the AIMLT MnS producer 520 triggers retraining, the ALML data monitoring function 530 may indicate 5011 the need for (re) training to AIML producer. The AIMLT MnS producer 520 may instantiate 5012 a training process and configure it with the required input. The AIML training entity 560 may perform 5013 the training or retraining of the AIML entity. The AIML training entity 560 may provide 5014 the updated training result to the AIMLT MnS producer 520.

In case of the ALML data monitoring function 530 instantiates the data monitoring process on its own, the ALML data monitoring function 530 may directly instantiate 5015 the AIML training process. The AIML training entity 570 may perform 5016 the training or retraining of the AIML entity. The AIML training entity 570 may provide 5017 the updated training result to the ALML data monitoring function 530. The ALML data monitoring function 530 may provide 5018 the updated training result to the AIMLT MnS producer 520. The AIMLT MnS producer 520 may then update or create 5019 the AIML entity based on whether the training performed was a retraining or new training respectively.

The AIMLT MnS producer 520 may forward 5020 the results to the AIMLT MnS Consumer 510.

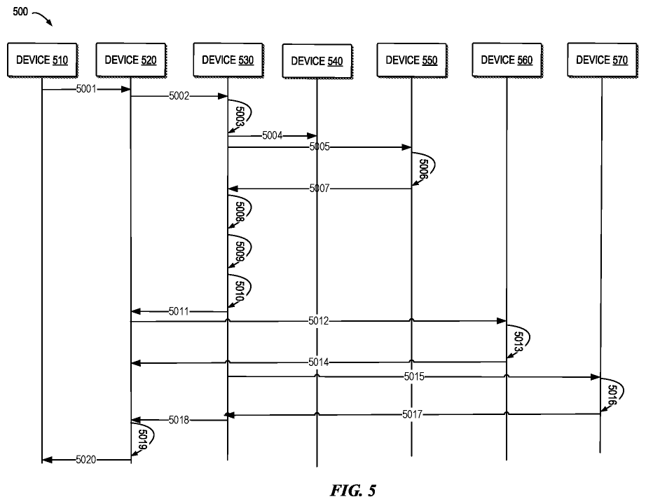

FIG. 6A illustrates a schematic diagram of class relationship associated with modeling of AIML entity. As shown in FIG. 6A, there may be a managed entity 611 which belongs to ProxyClass, an AIML training function 612 which belongs to InformationObjectClass, an AIML entity 613 which belongs to InformationObjectClass, an AIML training request 614 which belongs to InformationObjectClass, an AIML training process 615 which belongs to InformationObjectClass, and an AIML training report 616 which belongs to InformationObjectClass. FIG. 6B illustrates a schematic diagram of class inheritance associated with modeling of AIML entity. As shown in FIG. 6B, there may be a top 621 which belongs to InformationObjectClass, an AIML training request 622 which belongs to InformationObjectClass, an AIML training process 623 which belongs to InformationObjectClass, an AIML training report belongs to InformationObjectClass, an AIML entity 625 which belongs to InformationObjectClass, an AIML training function 626 which belongs to InformationObjectClass, and a managed function 627 which belongs to InformationObjectClass.

FIG. 6C illustrates a schematic diagram of class relationship associated with modeling of data monitoring. As shown in FIG. 6C, there may be an managed entity 631 which belongs to ProxyClass, an AIML entity 632 which belongs to InformationObjectClass, an AIML training function 633 which belongs to InformationObjectClass, an AIML training request 634 which belongs to InformationObjectClass, an AIML training process 635 which belongs to InformationObjectClass, an AIML training report 636 which belongs to InformationObjectClass, and an AIML data monitoring function 637 which belongs to InformationObjectClass. FIG. 6D illustrates a schematic diagram of class inheritance associated with modeling of data monitoring. As shown in FIG. 6D, there may be a top 641 which belongs to InformationObjectClass, an AIML training request 642 which belongs to InformationObjectClass, an AIML training process 643 which belongs to InformationObjectClass, an AIML training report 644 which belongs to InformationObjectClass, an AIML data monitoring function 645 which belongs to InformationObjectClass, an AIML training function 646 which belongs to InformationObjectClass, and a managed function 647 which belongs to InformationObjectClass. In some example embodiments, due to the complexity and time-varying nature of network, the AI/ML entities previously deployed may no longer be applicable to the network after running for a period of time. The performance of a trained model may degrade over time. The AI/ML entities need to be updated timely to ensure the performance of inference and analysis. The performance of the AIML entity may depend on the commonality of the distribution of the data used for training and the distribution of the data used for inference. The model performance may be good soon after deployment. This is because the chances of the distributions of the data used for training and the samples picked for inference are same. As the time progresses, the distribution of the network data might change as compared to the distribution of the train data. In such scenario, the performance of the AIML entity degrades over time. Hence there is a need for monitoring the network events such as PMs, KPIs, alarms and the like and use this information in the producer to decide on the retraining. Table 6 shows an example of retraining of AIML entity initiated by producer based on network events. It is noted that Table 6 is only an example not limitation.

TABLE 6

| | | Related use |
|---|---|---|
| Requirement label | Description | case(s) |
| REQ-AIML_RETR- | The AIML MnS producer shall have the | AI/ML entities |
| CON-1 | capability of allowing an authorized AIML | updating |
| | MnS consumer to provide the events to be | initiated by |
| | monitored to trigger the retraining of an | producer (clause |
| | AIML entity | 5.X.2.2) |
| REQ-AIML_RETR- | The AIML MnS producer shall have the | AI/ML entities |
| CON-2 | capability of using the events provided by | updating |
| | authorized MnS consumer to monitor and | initiated by |
| | trigger the retraining of an AIML entity | producer (clause |
| | | 5.X.2.2) |
| REQ-AIML_RETR- | The AIML MnS producer shall have the | AI/ML entities |
| CON-3 | capability of allowing an authorized AIML | updating |
| | MnS consumer to update the AIML entity | initiated by |
| | with the data events to be monitored to | producer (clause |
| | trigger the retraining of that AIML entity | 5.X.2.2) |

### Example Methods

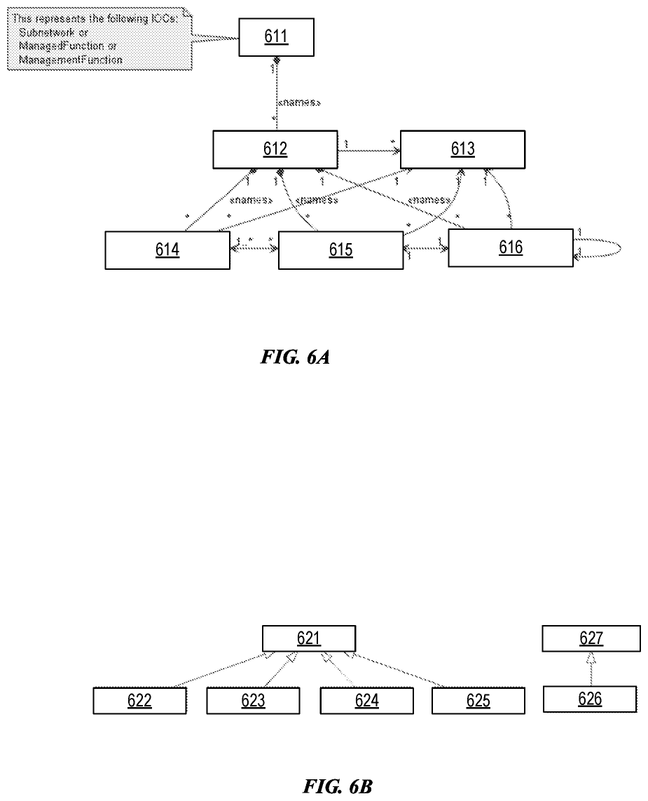

FIG. 7 shows a flowchart of an example method 700 implemented at or performed by a first device in accordance with some example embodiments of the present disclosure. For the purpose of discussion, the method 700 will be described from the perspective of the device 110 in FIG. 1A and FIG. 1B. In some embodiments, the device 110 may be separated from the device 120. Alternatively, the device 110 may be inside the device 120.

At block 710, the device 110 receives, from a device, a configuration indicating a data event associated with a model to be monitored. In some example embodiments, the device 110 may receive the configuration from the device 120. Alternatively, the device 110 inside the device 120 may receive the configuration from the device 130.

The data event indicates: a parameter to be monitored and a threshold associated with the parameter. The data event may comprise one or more of: a threshold direction, a hysteresis value, or a threshold periodicity of a notification associated with the crossing of the threshold. In some example embodiments, the parameter may comprise a performance measurement. Alternatively, or in addition, the parameter may comprise a key performance indicator. In some example embodiments, the parameter may comprise one or more of: a network control parameter, a network performance metric, or a communication environment parameter.

At block 720, the device 110 triggers monitoring of the parameter based on the configuration indicating the data event. For example, the device 110 may trigger a fifth device for monitoring the parameter.

At block 730, the device 110 detects whether a value of the parameter fulfills a condition in the configuration while monitoring the parameter.

In some example embodiments, the device 110 may determine the model to be updated based on the monitoring information. In this case, based on determining the model to be updated, the device 110 may transmit to the device 120 an indication regarding the model to be updated.

In some example embodiments, the device 110 may determine a periodicity of a notification associated with the crossing of the threshold. The device 110 may determine a threshold direction of the crossing of the threshold. In this case, in some example embodiments, the device 110 may determine whether the model needs to be updated based on the periodicity of notification and the threshold direction.

In some example embodiments, the device 110 may determine whether the periodicity is reached the threshold periodicity. The device 110 may determine whether the threshold direction satisfies a configured direction. In this case, in some example embodiments, based on determining that the periodicity of notifications reaches the threshold periodicity and the threshold direction satisfies the configured direction, the device 110 may determine that the model needs to be updated.

In some example embodiments, the parameter may comprise a key performance indicator. In this case, the device 110 may determine a performance measurement to be monitored for the key performance indicator.

In some example embodiments, the monitoring information may comprise a monitored performance measurement. In this case, the device 110 may determine determining a key performance indicator based on the monitored performance measurement.

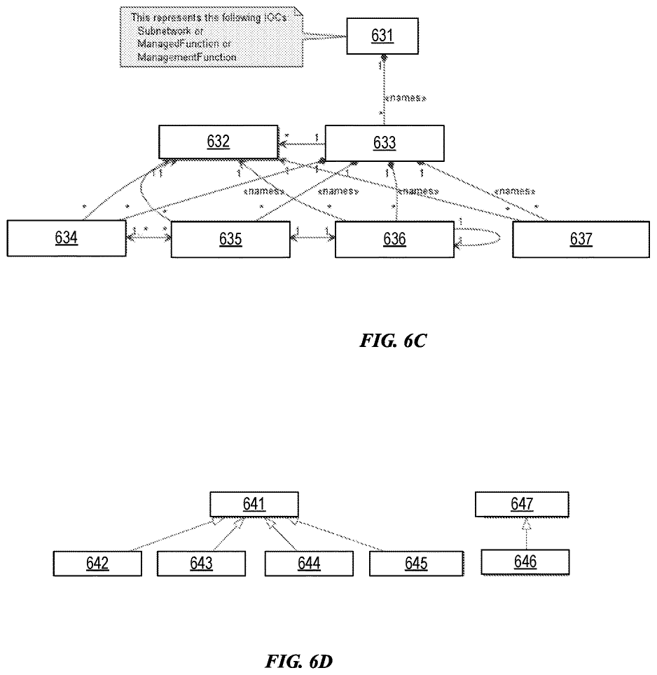

FIG. 8 shows a flowchart of an example method 800 implemented at a second device in accordance with some example embodiments of the present disclosure. For the purpose of discussion, the method 800 will be described from the perspective of the device 120 in FIG. 1A.

At block 810, the device 120 receives from the device 130, from a third device, a configuration indicating a data event associated with a model to be monitored. The data event indicates: a parameter to be monitored and a threshold associated with the parameter. The data event may comprise one or more of: a threshold direction, a hysteresis value, or a threshold periodicity of a notification associated with the crossing of the threshold. In some example embodiments, the parameter may comprise a performance measurement.

Alternatively, or in addition, the parameter may comprise a key performance indicator. In some example embodiments, the parameter comprises at least one of: a performance measurement, or a key performance indicator.

At block 820, the device 120 transmits the configuration indicating the data event to the device 110. In some example embodiments, the device 120 may receive from the device 110 an indication regarding the model to be updated. In this case, the device 120 may initiate a retraining of the model. The device 120 may receive from a fourth device an updated training result of the model. Alternatively, the device 120 may receive from the device 110 an updated training result of the model.

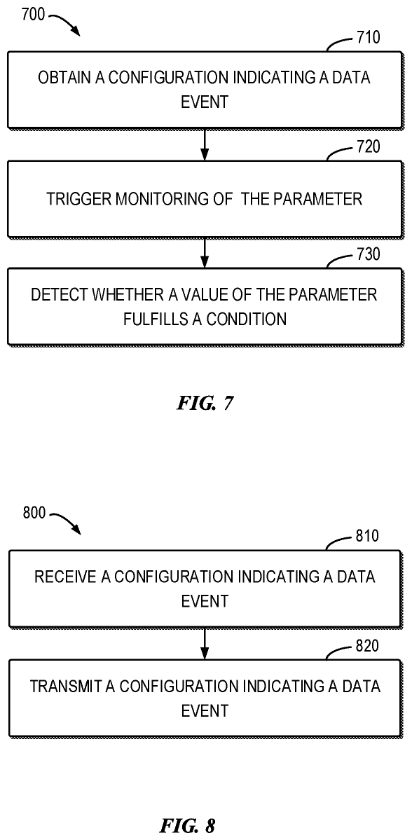

FIG. 9 shows a flowchart of an example method 900 implemented at a third device in accordance with some example embodiments of the present disclosure. For the purpose of discussion, the method 900 will be described from the perspective of the device 130 in FIG. 1A and FIG. 1B.

At block 910, the device 130 transmits, to the device 120, a configuration indicating a data event associated with a model to be monitored, the data event indicating: a parameter to be monitored and a threshold associated with the parameter. The data event indicates: a parameter to be monitored and a threshold associated with the parameter. The data event may comprise one or more of: a threshold direction, a hysteresis value, or a threshold periodicity of a notification associated with the crossing of the threshold. In some example embodiments, the parameter may comprise a performance measurement. Alternatively, or in addition, the parameter may comprise a key performance indicator. In some example embodiments, the parameter comprises at least one of: a performance measurement, or a key performance indicator.

In some example embodiments, at block 920, the device 130 may receive an result of a retraining of the model. In some example embodiments, the device 130 may reconfigure the data event to the device 120.

### Example Apparatus, Device and Medium

In some example embodiments, a first apparatus capable of performing any of the method 700 (for example, the device 110 in FIG. 1A and FIG. 1B) may comprise means for performing the respective operations of the method 700. The means may be implemented in any suitable form. For example, the means may be implemented in a circuitry or software module. In some example embodiments, the first apparatus may be implemented as or included in the device 110. Alternatively, the first apparatus may be implemented as or included in the device 120.

In some example embodiments, the first apparatus comprises means for obtaining, at a device, a configuration indicating a data event for data associated with a model to be monitored, the data event indicating: a parameter to be monitored and a threshold associated with the parameter; means for triggering monitoring of the parameter based on the configuration indicating the data event; and means for detecting whether a value of the parameter fulfills a condition indicated in the configuration while monitoring the parameter.

In some example embodiments, the means for obtaining the configuration indicating the data event comprises: means for receiving from another device the configuration indicating the data event.

In some example embodiments, the first apparatus comprises means for based on determining that the value of the parameter fulfills the condition, updating the model.

In some example embodiments, the first apparatus comprises means for based on determining the value of the parameter fulfills the condition, triggering updating the model.

In some example embodiments, the means for updating the model comprises at least one of: means for training the model; means for retraining the model; means for updating a hyper parameter of the model; means for updating the configuration indicating the data event associated with the model; or means for updating a running context of the model.

In some example embodiments, the parameter comprises at least one of: a network control parameter, a network performance metric, a communication environmental parameter, a performance measurement, or a key performance indicator.

In some example embodiments, the data event also comprises at least one of: a threshold direction, a hysteresis value, or a threshold periodicity of a notification associated with fulfilling the condition.

In some example embodiments, the first apparatus comprises means for transmitting to the second device an update training or retraining result of model.

In some example embodiments, the means for detecting whether a value of the parameter fulfills the condition indicated in the configuration comprises: means for determining a periodicity of a notification associated with a crossing of the threshold; means for determining a threshold direction of the crossing of the threshold; and means for determining whether the value of the parameter fulfills the condition based on the periodicity of notification and the threshold direction.

In some example embodiments, the first apparatus comprises means for determining whether the periodicity reaches the threshold periodicity; means for determining whether the threshold direction satisfies a configured direction indicated in the configuration; and means for based on determining that the periodicity of notifications reaches the threshold periodicity and the threshold direction satisfies the configured direction, determining whether the value of the parameter fulfills the condition.

In some example embodiments, the device comprises an artificial intelligent machine learning (AIML) monitoring function, or the device comprises an artificial intelligent machine learning producer with artificial intelligent machine learning monitoring function.

In some example embodiments, a second apparatus capable of performing any of the method 800 (for example, the device 120 in FIG. 1A) may comprise means for performing the respective operations of the method 800. The means may be implemented in any suitable form. For example, the means may be implemented in a circuitry or software module. The second apparatus may be implemented as or included in the device 120 in FIG. 1.

In some example embodiments, the second apparatus comprises means for receiving, from a third device, a configuration indicating a data event associated with a model to be monitored, the data event indicating: a parameter to be monitored and a threshold associated with the parameter; and means for transmitting the configuration indicating the data event to the first device.

In some example embodiments, the data event also comprises at least one of: a threshold direction, a hysteresis value, or a threshold periodicity of a notification associated with the crossing of the threshold.

In some example embodiments, the second apparatus further comprises means for receiving from the first device an indication about updating the model; means for initiating a retraining of the model; means for receiving from a fourth device an updated training result of the model.

In some example embodiments, the second apparatus further comprises means for receiving from the first device an updated training result of the model.

In some example embodiments, the parameter comprises at least one of: a performance measurement, or a key performance indicator.

In some example embodiments, the second apparatus further comprises means for transmitting to the third device the updated training result of the model.

In some example embodiments, the second apparatus further comprises means for performing other operations in some example embodiments of the method 800 or the device 120. In some example embodiments, the means comprises at least one processor; and at least one memory storing instructions that, when executed by the at least one processor, cause the performance of the second apparatus.

In some example embodiments, a third apparatus capable of performing any of the method 900 (for example, the device 130 in FIG. 1A and FIG. 1B) may comprise means for performing the respective operations of the method 900. The means may be implemented in any suitable form. For example, the means may be implemented in a circuitry or software module. The second apparatus may be implemented as or included in the device 130 in FIG. 1A and FIG. 1B.

In some example embodiments, the third apparatus comprise means for transmitting, at a device and to another device, a configuration indicating a data event for data associated with a model to be monitored, the data event indicating: a parameter to be monitored and a threshold associated with the parameter.

In some example embodiments, the parameter comprises at least one of: a network control parameter, a network performance metric, a communication environmental parameter, a performance measurement, or a key performance indicator.

In some example embodiments, the data event also comprises at least one of: a threshold direction, a hysteresis value, or a threshold periodicity of a notification associated with fulfilling the condition.

In some example embodiments, the third apparatus comprise means for receiving from the other device an updated training or retraining result of the model.

In some example embodiments, the device comprises an artificial intelligent machine learning consumer.

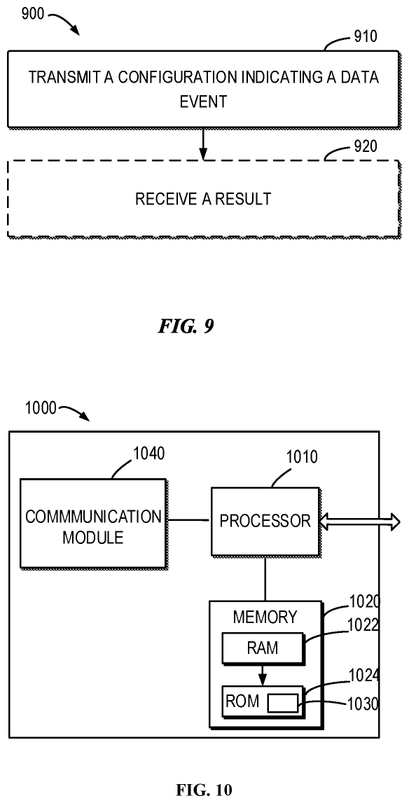

FIG. 10 is a simplified block diagram of a device 1000 that is suitable for implementing example embodiments of the present disclosure. The device 1000 may be provided to implement a communication device, for example, the device 110 or the device 120 as shown in FIG. 1A and FIG. 1B. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The instructions of the program 1030 may include instructions for performing operations/acts of some example embodiments of the present disclosure. The program 1030 may be stored in the memory, e.g., the ROM 1024. The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIG. 2A to FIG. 9. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

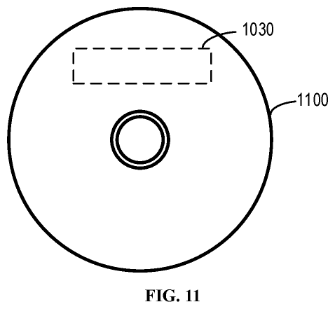

FIG. 11 shows an example of the computer readable medium 1100 which may be in form of CD, DVD or other optical storage disk. The computer readable medium 1100 has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A device comprising:
at least one processor; and
at least one memory storing instructions that, when executed by the at least one processor, cause the device at least to perform operations, the operations comprising:
obtaining a configuration indicating a data event associated with a model, wherein the data event is to be monitored to determine whether to retrain the model, the data event comprises: a parameter; and a threshold associated with the parameter, wherein the parameter comprises a performance measurement or a key performance indicator;
triggering monitoring of the data event; and
based on detecting that a value of the parameter satisfies the threshold associated with the parameter, retraining the model or triggering retraining of the model.

2. The device of claim 1, wherein the obtaining the configuration indicating the data event comprises:
receiving from another device the configuration indicating the data event.

3-6. (canceled)

7. The device claim 1, wherein the data event further comprises at least one of:
a threshold direction; or
a hysteresis value.

8. The device of claim 1, wherein the operations further comprise:
transmitting to another device a retraining result of the retraining the model.

9. The device of claim 7, wherein the data event comprises the threshold direction and wherein the detecting a that the value of the parameter satisfies the threshold associated with the parameter comprises:
determining that the value of the parameter crossed the threshold in the threshold direction.

10. The device of claim 9, wherein the data event further comprises the hysteresis value and wherein the determining that the value of the parameter crossed the threshold in the threshold direction considering the hysteresis value.

11. The device of claim 1, wherein the device comprises an artificial intelligent machine learning producer with artificial intelligent machine learning monitoring function.

12-16. (canceled)

17. A method comprising:
obtaining, at a device, a configuration indicating a data event associated with a model, wherein the data event is to be monitored to determine whether to retrain the model, the data event comprising: a parameter; and a threshold associated with the parameter, wherein the parameter comprises a performance measurement of the model or a key performance indicator of the model;
triggering, at the device, monitoring of the data event; and
based on detecting that a value of the parameter satisfies the threshold associated with the parameter, retraining the model or triggering retraining of the model.

18. The method of claim 17, wherein the obtaining the configuration indicating the data event comprises:
receiving from another device the configuration indicating the data event.

19-22. (canceled)

23. The method of claim 17, wherein the data event further comprises at least one of:
a threshold direction; or
a hysteresis value.

24. The method of claim 17, further comprising:
transmitting to another device a retraining result of the retraining the model.

25. The method of claim 23, wherein the data event comprises the threshold direction and wherein the detecting that a value of the parameter satisfies the threshold associated with the parameter comprises:
determining that the value of the parameter crossed the threshold in the threshold direction.

26. The method of claim 25, wherein the data event further comprises the hysteresis value, and data event comprises the hysteresis value and wherein the determining that the value of the parameter crossed the threshold in the threshold direction considering the hysteresis value.

27. The method of claim 17,
wherein the device comprises an artificial intelligent machine learning producer with artificial intelligent machine learning monitoring function.

28-34. (canceled)

35. A non-transitory computer readable medium comprising instructions stored thereon which, when executed by at least one processor of a device cause the device to perform:
obtaining, a configuration indicating a data event associated with a model, wherein the data event is to be monitored to determine whether to retrain the model, the data event comprising: a parameter; and a threshold associated with the parameter, wherein the parameter comprises a performance measurement of the model or a key performance indicator of the model;
triggering a monitoring of the data event; and
based on detecting that a value of the parameter satisfies the threshold associated with the parameter, retraining the model or triggering retraining of the model.

36. The non-transitory computer readable medium of claim 35, wherein the obtaining the configuration indicating the data event comprises:
receiving from another device the configuration indicating the data event.

37. The non-transitory computer-readable medium as of claim 35, wherein the data event further comprises at least one of:
a threshold direction; or
a hysteresis value.

38. The non-transitory computer-readable medium of claim 35, wherein the instructions, when executed by the at least one processor, further cause the device to perform:
transmitting to another device a retraining result of the retraining of the model.

39. The non-transitory computer-readable medium of claim 37, wherein the data event comprises the threshold direction and wherein the detecting that a value of the parameter satisfies the threshold associated with the parameter comprises:
determining that the value of the parameter crossed the threshold in the threshold direction.

40. The non-transitory computer-readable medium of claim 39, wherein the data event further comprises the hysteresis value, and wherein the determining that the value of the parameter crossed the threshold in the threshold direction considering the hysteresis value.

41. The non-transitory computer-readable medium of claim 35, wherein the device comprises an artificial intelligent machine learning producer with artificial intelligent machine learning monitoring function.
